(19) United States
(12) Patent Application Publication
(10) Pub. No.: US 2022/0138626 A1
(43) Pub. Date: May 5, 2022

(54) System For Collaboration And Optimization Of Edge Machines Based On Federated Learning

(71) Applicant: Tsinghua University, Beijing (CN)

(72) Inventor: De BI, Beijing (CN)

(21) Appl. No.: 17/451,434

(22) Filed: Oct. 19, 2021

(30) Foreign Application Priority Data
Nov. 2, 2020 (CN) 202011186697.8

(51) Int. Cl. G06N 20/00; G06F 9/50; H04L 9/00

(52) U.S. Cl. CPC G06N 20/00; G06F 2209/501; H04L 9/008; G06F 9/5027

(57) ABSTRACT

A system for collaboration and optimization of edge machines based on federated learning is provided. The system includes R federated learning systems, R≥1, a model parameter assignment unit, and model training and optimizing units. The model parameter assignment unit is configured to assign initial parameters for federated learning to the Mᵢ edge machines, receive intermediate model parameters, and aggregate and update the received intermediate model parameters to obtain new model parameters. The model training and optimizing units are configured to train, on the basis of the initial parameters and respective operating data, local operating models, transmit the intermediate model parameters obtained after training to the model parameter assignment unit, and obtain a system collaborative operating model according to the new model parameters.

### RELATED APPLICATION(S)

This application claims priority under 35 U.S.C. § 119 or 365 to China, Application No. 202011186697.8, filed Nov. 2, 2020. The entire teachings of the above application(s) are incorporated herein by reference.

### TECHNICAL FIELD

The present disclosure belongs to a technical field of digital system integration, and relates to a system for collaboration and optimization of edge machines based on federated learning.

### BACKGROUND

Due to the development of internet of things, the emergence of edge computing, and the rapid popularization of industrial internet, each edge/terminal device or machine becomes a main body of big data. For instance, lathes, automated guided vehicles (AGV) or industrial robots in workshops, mining machines or transport vehicles in a mine, and various inspection robots and unmanned intelligent vehicles are all main sources of big data, and also carriers for data computation and application. However, in view of data security, these massive data form a huge amount of data islands instead of being applied effectively, and does not provide effective support for single machine operation optimization, system operation and business requirements.

Industrial intelligence can be advanced with high-value data application. Besides, effective data sharing and application among machines are essential for development of industrial applications (apps), modeling of industrial mechanisms, optimization of industrial processes, an adjustment and response to operating conditions of a specific scenario, a system of machines and business requirements, and collaboration among multiple machines in the system. At present, massive data may be generated by intelligent machines, but there are no effective tools and ways to specifically apply big data of each edge machine on the premise of ensuring security and credibility of the data.

With regard to learning and optimization of the edge machine, by virtue of artificial intelligence (AI), training and modeling are mostly carried out on the cloud, and applications are deployed on the edges. For example, an algorithm model for predicting residual service life of a machine bearing and assessing and analyzing health of the machine bearing is developed, on the basis of a TensorFlow platform, by an industrial internet platform in China. The algorithm model is deployed to the cloud for training and prediction to provide users with corresponding services via application programming interfaces (APIs). The service requires the users to upload operating data of machines in real time, and then the data is cleaned, converted and preprocessed at a data service layer of a system platform. However, such a way cannot guarantee data privacy of edge machines, because all data generated during operations of machines will be collected by AI service provider.

Therefore, numerous enterprises encounter with a dilemma of “the more information systems and intelligent systems, the more information islands”. For an enterprise, data should be understood and used ultimately, but there is no link between numerous data storage and application systems of the enterprise and the latest big data technology solutions, which makes it hard to effectively match data with business requirements and convert data resources of the enterprise into data assets.

In addition, as an increasing data volume in internet of things, a centralized mode of cloud computing is not good for some business scenarios. For example, for machines in industrial fields with long time delay, communication delays in cloud management and control will affect execution efficiency and user experience.

### SUMMARY

### (I) Technical Problems

The present disclosure provides a system for collaboration and optimization of edge machines based on federated learning, so as to at least partially solve the above technical problems.

### (II) Technical Solutions

One aspect of the present disclosure provides the system for collaboration and optimization of the edge machines based on the federated learning. The system includes R federated learning systems, R≥1, a model parameter assignment unit and model training and optimizing units. The i-th federated learning system in the R federated learning systems includes Mᵢ edge machines with uneven operating experience distribution, Mᵢ≥2, i=1, 2, . . . , R. The model parameter assignment unit is configured to assign initial parameters for federated learning to the Mᵢ edge machines in the i-th federated learning system, receive intermediate model parameters transmitted by the model training and optimizing units, and aggregate and update the received intermediate model parameters to obtain new model parameters. The model training and optimizing units are arranged in the Mᵢ edge machines respectively. The model training and optimizing units are configured to train, on the basis of the initial parameters assigned by the model parameter assignment unit and respective operating data, local operating models, transmit the intermediate model parameters obtained after training to the model parameter assignment unit, and obtain a system collaborative operating model of the i-th federated learning system according to the new model parameters. The local operating models are models in response to different operating environments.

According to an embodiment of the present disclosure, the Mᵢ edge machines include Tᵢ specific edge machines with operating experience not meeting predetermined requirements, 1≤Tᵢ<Mᵢ. The system further includes: scenario feature model optimizing units. The scenario feature model optimizing units are arranged in the Tᵢ specific edge machines, and are configured to carry out, on the basis of the system collaborative operating model and working scenario features of the Tᵢ specific edge machines, model optimization, to increase single machine intelligence and improve capabilities of the Tᵢ specific edge machines to respond to environments, in which the Tᵢ specific edge machines are located, and to execute tasks.

According to an embodiment of the present disclosure, the operating experience not meeting the predetermined requirements includes one of: the number of operating scenarios experienced being lower than a predetermined value; the quantity of operating data being less than a predetermined quantity; or operating duration being shorter than predetermined time.

According to an embodiment of the present disclosure, when the Mᵢ edge machines in the i-th federated learning system are organizations with visible data privacy, the intermediate model parameters are transmitted without encryption. When the Mᵢ edge machines in the i-th federated learning system are organizations with invisible data privacy, the intermediate model parameters need to be transmitted with encryption.

According to an embodiment of the present disclosure, the encryption includes homomorphic encryption, and the homomorphic encryption includes fully homomorphic encryption.

According to an embodiment of the present disclosure, the system further includes a machine selection unit, a task model parameter assignment unit and task model training and optimizing units. The machine selection unit is configured to select edge machines with performance scores of executing a target task higher than a predetermined score value in each of the R federated learning systems to obtain a task training alliance. The task model parameter assignment unit is configured to assign task initial parameters to the edge machines in the task training alliance, receive the task model intermediate parameters transmitted by the task model training and optimizing units, and aggregate and update the received task model intermediate parameters to obtain new task model parameters. The task model training and optimizing units are arranged in the edge machines in the task training alliance respectively, and are configured to train, on the basis of the task initial parameters assigned by the task model parameter assignment unit and respective operating data, local operating models for the target task, encrypt the task model intermediate parameters obtained after training and transmit the encrypted task model intermediate parameters to the task model parameter assignment unit, and obtain a system collaborative execution task model of the task training alliance according to the new task model parameters. The local operating models for the target task are models for executing the target task in different operating environments.

According to an embodiment of the present disclosure, the model parameter assignment unit is further configured for recording and making statistics on activity data in the federated learning systems, wherein recording and making statistics on activity data in the federated learning systems include: the number of the edge machines participating in computation, the number of model transfers, and transmission and convergence determination of the updated model parameters.

According to an embodiment of the present disclosure, an edge machine with a computing capability and storage capability meeting predetermined requirements in the Mᵢ edge machines serves as the model parameter assignment unit.

According to an embodiment of the present disclosure, a cloud server or an edge server capable of communicating with the Mᵢ edge machines serves as the model parameter assignment unit.

According to an embodiment of the present disclosure, each of the Mᵢ edge machines in the i-th federated learning system in the R federated learning systems further includes: a data acquisition module, a storage unit, a computing unit and a communication module. The data acquisition module is configured to acquire an image, a movement track, operating data and environment responding data. The storage unit is configured to store the operating data for model training. One part of the computing unit is configured to execute a predetermined working task, and the other part thereof is configured to execute a task for the federated learning. The communication module may support wired communication and wireless communication, where the wireless communication involves a 5G communication module.

### (III) Beneficial Effects

It may be seen from the above technical solutions that the system for collaboration and optimization of the edge machines based on the federated learning provided by the present disclosure has following beneficial effects:

(1) The edge machines form the federated learning systems, and by training the system collaborative operating model, an intelligent level of the single machine may be improved, operating efficiency of the single machine may be optimized and improved, an intelligent process of the single machine may be accelerated, rapid adjustment and adaptation capabilities to operating conditions may be improved, and working efficiency may be constantly optimized.

(2) Collaboration among intelligent machines is promoted, computing and storage resources are effectively allocated and applied, high-value application of the machines is realized, an application rate of hardware assets is improved, and depreciation of the hardware assets is retarded.

(3) Data application and model training are promoted, scenario-based application of artificial intelligence (AI) is accelerated, and conversion of data to value is accelerated.

(4) Data are isolated, and may not be leaked to the outside, such that the requirements of user privacy protection and data security are met.

(5) Data islands are broken down, and collaborative application of island data is improved.

(6) Collaboration among the machines in the system is improved, rapid decomposition of the system task is optimized, and adaptability of the system to more complex working tasks in dynamically changing environments is enhanced, for example, processes in production and manufacturing environments are optimized, and overall efficiency of the system is improved.

(7) The system collaborative execution task model obtained by joint training of the members in the task training alliance may improve the overall efficiency of the system, for example, the same enterprise or group may have N factories with the same or similar machines and production tasks, but efficiency of each factory is different, and through optimization of single machine data training and modeling based on the federated learning, machine data training and performance optimization of systems may be further carried out.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a structural schematic diagram of a system for collaboration and optimization of edge machines based on federated learning according to one embodiment of the present disclosure;

FIG. 2 is a structural block diagram of a system for collaboration and optimization of edge machines based on federated learning according to another embodiment of the present disclosure;

FIG. 3 is a schematic diagram of structure and application of the system for collaboration and optimization of the edge machines based on the federated learning according to the embodiments of the present disclosure; and

FIG. 4 is a schematic diagram of a framework of the system for collaboration and optimization of the edge machines based on the federated learning according to the embodiments of the present disclosure.

### DETAILED DESCRIPTION

Federated learning, first proposed by Google Inc. in 2016, aims to complete joint modeling without data sharing. That is, in a case that data held by a data owner may be stored locally, through a parameter exchange mode under an encryption mechanism in a federated system, a global sharing model based on a distributed data set is established, such that the established model serves a local computing target, model information may be exchanged among all parties in an encryption form or unencryption form, while the data may be stored locally without data privacy exposure and data breaches.

In China, some companies have made certain progress in research on federated learning in some industries, for example, the federated learning is applied to a financial field such as a banking industry and an insurance industry, is used for realizing multi-party collaboration and authorized sharing of e-commerce data, so as to be applied to a smart credit and risk control, and is applied to a medical field.

By contrast, less research and innovation are made on applying the federated learning to machines to improve efficiency of production and operation management.

An edge machine operation management and control method based on a cloud architecture may not quickly adapt, by means of small data samples, to environmental changes, and has deficiencies of slow responses to environmental changes and requirement of a large number of samples for learning. For example, for some functional machines, such as an outdoor inspection robot, of which working scenarios widely vary, it is difficult for a manufacturer to make overall preparations in advance, which, thus, requires these machines to have capabilities to learn and understand various scenarios.

A system for collaboration and optimization of edge machines based on the federated learning provided by the present disclosure has advantages of the federated learning, and improves data applications on the premise of ensuring that the data does not depart from the owner (which may be a machine, a factory or an enterprise) and ensuring safe and credible application of the data on the basis of the federated learning. The application of federated learning to collaborative modeling for data of edge machines can effectively accelerate data circulation and sharing among the edge machines, promote modeling and training of an industrial mechanism, optimize working quality that the machines respond to different operating conditions, enhance collaboration with environments and business processes, and improve operating efficiency. Meanwhile, it can improve capabilities of a similar machine or even different machine to use small data for training and learning, and capabilities to adapt and respond to environments.

In the present disclosure, data modeling and application of the edge machines are carried out by the federated learning, where on the premise of ensuring security and credibility of the data, the data on the different machines are used for model training and model reasoning, to achieve edge applications without data breaches and improve the conventional centralized application mode where data are gathered in the cloud for data analysis and modeling. The present disclosure provides support for promoting data application and modeling of the industrial mechanism of the different machines, and finally provides support for optimizing machine operation, improving operating conditions and improving working efficiency of the single machine and the system.

In order that the purposes, the technical solutions and the advantages of the present disclosure are more clearly understood, the present disclosure will be described in further detail below with reference to the drawings and the detailed description thereof.

The first exemplary embodiment of the present disclosure provides a system 100 for collaboration and optimization of the edge machines 102 based on the federated learning.

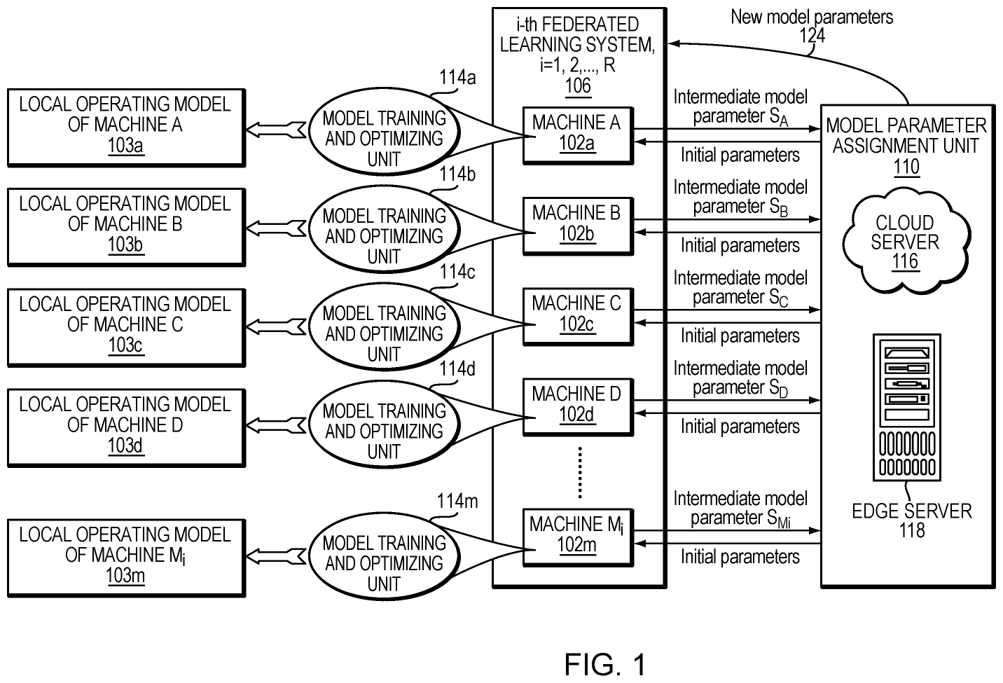

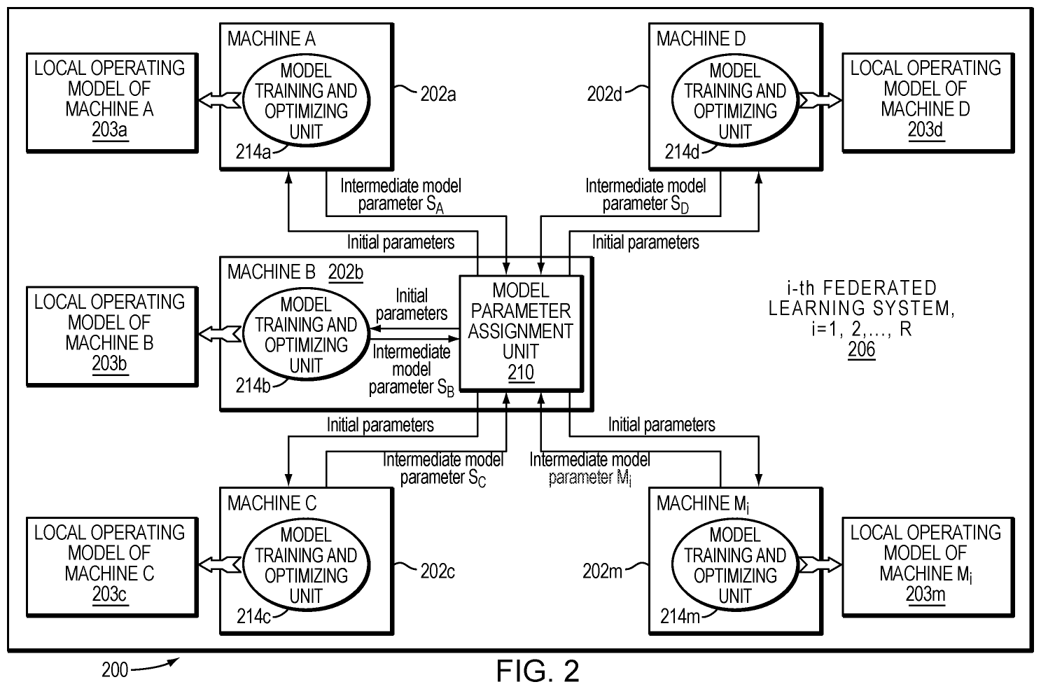

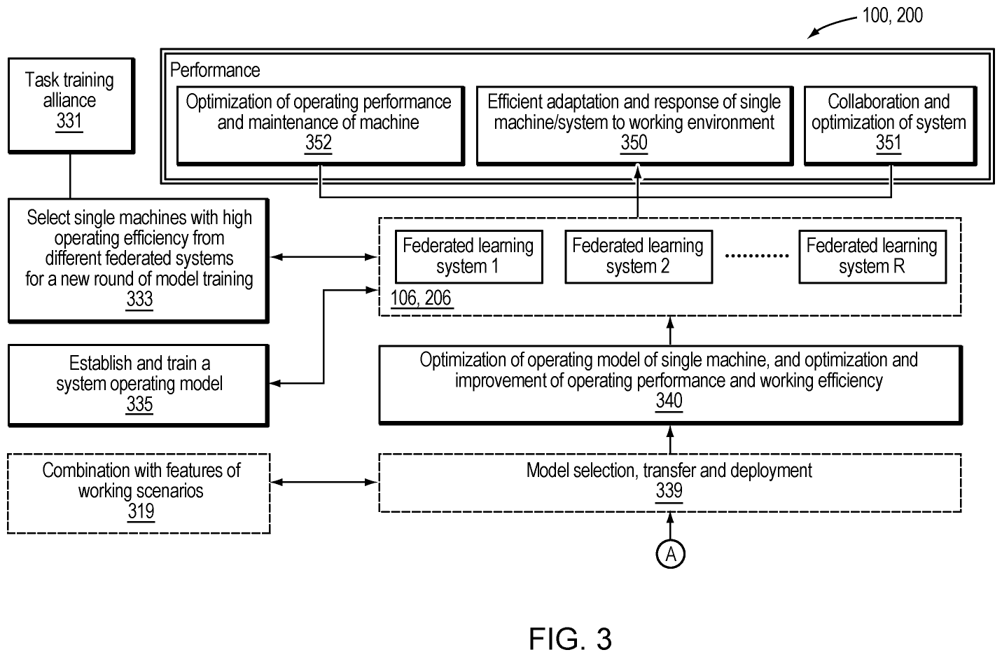

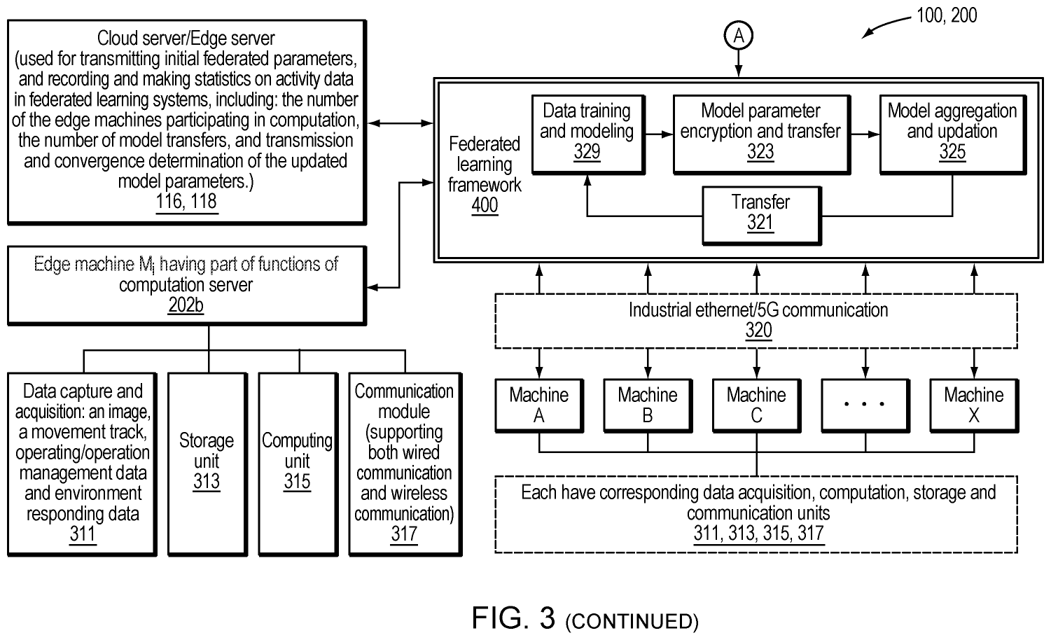

FIG. 1 is a structural schematic diagram of the system 100 for collaboration and optimization of the edge machines 102 a, b, c, . . . m (102 generally) based on the federated learning according to one embodiment of the present disclosure. FIG. 2 is a structural block diagram of the system 200 for collaboration and optimization of the edge machines 202 a, b, c, . . . m (202 generally) based on the federated learning according to another embodiment of the present disclosure. FIG. 3 is a schematic diagram of structure and application of the system 100, 200 for collaboration and optimization of the edge machines based on the federated learning according to the embodiments of the present disclosure.

As shown in FIGS. 1-3, the system 100, 200 for collaboration and optimization of the edge machines of based on the federated learning in the present disclosure includes R federated learning systems 106, 206, R≥1; a model parameter assignment unit 110, 210 and model training and optimizing units 114, 214 (generally). The i-th federated learning system in the R federated learning systems 106, 206 includes Mᵢ edge machines 102, 202 with uneven operating experience distribution, wherein Mᵢ≥2, i=1, 2, . . . , R.

One or some of the edge machines 102, 202 included in the i-th federated learning system may be included in the j-th federated learning system in the above R federated learning systems 106, 206, j≠i, j=1, 2, . . . , R, and the federated learning systems are organized and constructed according to real scenarios and task requirements.

In FIG. 1, the Mᵢ edge machines 102a, 102b, 102c, . . . 102m are illustrated as machine A, machine B, machine C, machine D, . . . , and machine Mᵢ respectively.

The model parameter assignment unit 110 is configured to assign initial parameters for the federated learning to the Mᵢ edge machines 102 in the i-th federated learning system 106, receive intermediate model parameters transmitted by the model training and optimizing units 114a, 114b, 114c, . . . 114m (114 generally), and aggregate and update the received intermediate model parameters Sₐ, . . . Sₘᵢ to obtain new model parameters 124.

According to the embodiments of the present disclosure, as shown in FIGS. 2 and 3, an edge machine 202b with a computing capability and storage capability meeting predetermined requirements of the Mᵢ edge machines serves as the model parameter assignment unit 210. For example, as shown in FIG. 2, the machine B (202b) serves as the model parameter assignment unit 210, and a part of computation resources and storage resources are reserved in the machine B for realizing functions of the model parameter assignment unit.

According to the embodiments of the present disclosure, as shown in FIGS. 1 and 3, a cloud server 116 or an edge server 118 capable of communicating with the Mᵢ edge machines 102 serves as the model parameter assignment unit 110.

As shown in FIGS. 1 and 2, the model training and optimizing units 114a, b, m (114 generally) and 214a, b, . . . m (214 generally) are arranged in the Mᵢ edge machines 102, 202 respectively. The model training and optimizing units 114, 214 are configured to train, on the basis of the initial parameters assigned by the model parameter assignment unit 210 and respective operating data; local operating models 103a, 103b, . . . 103m (103 generally) and 203a, 203b, . . . 203m (203 generally) encrypt the intermediate model parameters Sₐ, Sₘᵢ obtained after training and transmit the encrypted intermediate model parameters to the model parameter assignment unit 110, 210, and obtain a system collaborative operating model of the i-th federated learning system 106, 206 according to the new model parameters 124. The local operating models are models 103, 203 in response to different operating environments.

According to the embodiments of the present disclosure, the Mᵢ edge machines include Tᵢ specific edge machines with operating experience lower than predetermined requirements, 1≤Tᵢ<Mᵢ. The system 100, 200 further includes: scenario feature model optimizing units. The scenario feature model optimizing units are arranged in the Tᵢ specific edge machines, and are configured to carry out, on the basis of the system collaborative operating model (generally at 339 FIG. 3) and working scenario features 319 (FIG. 3) of the Tᵢ specific edge machines, model optimization, to increase single machine intelligence and improve capabilities of the Tᵢ specific edge machines to respond to environments, in which the Tᵢ specific edge machines are located, and to execute tasks.

According to the embodiments of the present disclosure, the operating experience lower than the predetermined requirements includes one of: the number of operating scenarios experienced being lower than a predetermined value; the quantity of an operating data being less than a predetermined quantity; or operating duration being shorter than a predetermined time.

Features 319 (FIG. 3) of mobility of intelligent edge machines, multi-scenario, and rapid change and timely acquisition of data are fully combined for modeling.

In the present disclosure, by carrying out cross-scenario federated modeling on an identical kind of machines with uneven operating experience distribution, a deficiency that the identical kind of machines may not rapidly accumulate a large amount of operating data of different scenarios in different operating conditions and scenarios is made up, such that the machines may rapidly accumulate capabilities to operate, with relatively high quality, in various operating conditions and scenarios, realize capabilities of the machines to learn and adapt to different scenarios with small data, expand universality of working capabilities of the machines, and reduce cost of machine optimization and iterative development, time cost of debugging and testing of the machines in new operating conditions, and use cost of the machines, and the machines may also be suitable for more new operating conditions after the tasks are completed in a certain post.

At the same time, for those novice machines with insufficient operating experience, such as insufficient operation management/operating data or insufficient working scenarios, the operating data of those machines operating for a long time may be fully utilized to carry out federated modeling collaboratively so as to realize a goal of rapid machine learning with small data, optimize the operating conditions and environment responding capability of the single machine, and improve an intelligent level of the single machine.

An important feature of machine intelligence is rapid and high-quality response to the environments. In the present disclosure, selection, transfer and deployment of a federated model 339 (FIG. 3) are carried out in combination with the specific working scenarios 319 in which the machines are located, so as to improve accuracy and adaptability to the scenarios of the model, and optimize a model training process.

According to the embodiments of the present disclosure, when the Mᵢ edge machines in the i-th federated learning system are organizations with visible data privacy, the intermediate model parameters are transmitted without encryption. The organizations with visible data privacy may be in the same enterprise, institution or factory where data of various machines may be shared.

When the Mᵢ edge machines in the i-th federated learning system are organizations with invisible data privacy, the intermediate model parameters need to be transmitted with encryption (i.e., 323 FIG. 3). The organizations with invisible data privacy may be different enterprises, institutions or factories, or different departments, organizations or individuals in the same enterprise, and all or part of the data of various machines may not be shared.

According to the embodiments of the present disclosure, the encryption (at 323 FIG. 3) includes homomorphic encryption, and the homomorphic encryption includes fully homomorphic encryption.

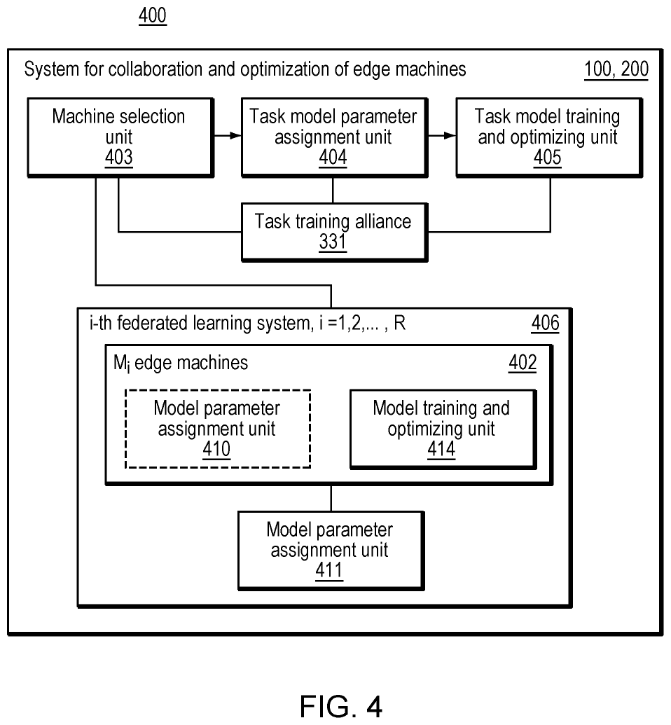

The data of the machines in the same enterprise or organization is relatively not strictly confidential. In comparison, the operating data of the machines in different enterprises or organizations is relatively strictly confidential, but at the moment, the data for joint modeling is required to be seen and used by each other, and thus with gradual improvement of algorithm efficiency and enhancement of computing power of intelligent machines, the full homomorphic encryption is gradually applied in data and computing encryption. In a collaborative modeling process of the data of the intelligent machines, the full homomorphic encryption is combined with the federated learning 400 (FIGS. 3, 4). In order to avoid a possibility that original data is obtained through inversion of a trained model, the original data of the intelligent machines is encrypted through the homomorphic encryption, then model training 329 (FIG. 5), 414 (FIG. 4) is performed on the encrypted data, such that the data may not leave the data owner, privacy of users may not be leaked, and privacy information and data security of the data owner are fully guaranteed. Intermediate results of the model training are encrypted 323 to ensure privacy and security of a model training process.

In the present disclosure, the model training 329, 414 is carried out by combining “privacy data protection” with data in the same system. For scenarios without data privacy protection requirements in the same system, data sharing and transfer may be directly carried out to obtain more and better training data.

FIG. 4 is a schematic diagram of a framework 400 of the system 100, 200 for collaboration and optimization of the edge machines based on the federated learning according to the embodiments of the present disclosure. In FIG. 4, in the i-th federated learning system 406, an edge machine 402 with a computing capability and storage capability meeting predetermined requirements of the Mᵢ edge machines serves as the model parameter assignment unit 410, as shown in a dashed line box. The model parameter assignment unit 411 may be located outside the Mᵢ edge machines, for example, the edge server 118 or the cloud server 116 serves as the model parameter assignment unit 110 (FIG. 1).

According to the embodiments of the present disclosure, as shown in FIG. 4, the system further includes a machine selection unit 403, a task model parameter assignment unit 404 and task model training and optimizing units 405.

The machine selection unit 403 is configured to select edge machines 402 with performance scores of executing a target task higher than a predetermined score value in each of the R federated learning systems to obtain a task training alliance 331.

The task model parameter assignment unit 404 is configured to assign task initial parameters to the edge machines in the task training alliance 331, receive the task model intermediate parameters transmitted by the task model training and optimizing units 405, and aggregate and update the received task model intermediate parameters to obtain new task model parameters.

The task model training and optimizing units 405 are arranged in the edge machines in the task training alliance 331 respectively, and are configured to train 329 (FIG. 3), on the basis of the task initial parameters assigned by the task model parameter assignment unit 404 and respective operating data, local operating models for the target task, encrypt 323 (FIG. 3) the task model intermediate parameters obtained after training and transmit the encrypted task model intermediate parameters to the task model parameter assignment unit 404, and obtain a system collaborative execution task model 325 (FIG. 3) of the task training alliance 331 according to the new task model parameters.

The local operating model (e.g., 103 203) for the target task is models 325 for executing the target task in different operating environments.

In a case that a working requirement and production task of each machine are constantly changed and adjusted instead of being fixed, the system collaborative execution task model 325 is constructed by learning among single machines with support of the federated learning, optimal decomposition of a system task, and self-learning and task assignment of the single machines, so that idle machines best matching execution tasks are used most efficiently and optimally.

An important feature of Industry 4.0 is flexible manufacturing, machines in multiple manufacturing processes may intelligently re-form, according to requirements of an order and current operating states, a flexible production line meeting the requirements of the current order, which may not be flexibly realized by machines which execute production tasks through pre-programming definition in the past. The solutions according to the present disclosure can help decomposition of the system task and collaboration among machines, increase flexibility of processes, and optimize quality.

Generally, a large number of machines exist in complex working scenarios 319, and due to changes of operators or operating conditions, operating efficiency of the same machine is different in power consumption, part loss, etc. Through learning and optimization of the members in the system 100, 200, an independent machine may make independent optimization adjustment 339, 340 or give reasonable working suggestions to the operators.

According to the embodiments of the present disclosure, as shown in FIG. 3, the model parameter assignment unit (at 116, 118) is further configured for recording and making statistics on activity data in the federated learning systems, wherein recording and making statistics on activity data in the federated learning systems include: the number of the edge machines participating in computation, the number of model transfers 321, and transmission and convergence determination of the updated model parameters 323.

According to the embodiments of the present disclosure, as shown in FIG. 3, each of the Mᵢ edge machines in the i-th federated learning system in the R federated learning systems 106, 206 further includes: a data acquisition module 311, a storage unit 313, a computing unit 315 and a communication module 317. The data acquisition module 311 is configured to acquire an image, a movement track, operating data and environment responding data. The storage unit 313 is configured to store the operating data for model training 414. One part of the computing unit 315 is configured to execute a predetermined working task, and the other part thereof is configured to execute a task for the federated learning 400. The communication module 317 may support wired communication and wireless communication, where the wireless communication involves a 5G communication module 320.

In order to ensure efficient, stable and timely data transfer, the 5G communication module 320 is used to improve data transmission and response speeds so as to control a delay in a range that does not affect operating efficiency, safety and stability of the machines A, . . . X.

A process that multiple machines jointly complete one system task is described with reference to one embodiment. Herein, garbage sorting is taken for example. High-quality garbage sorting may facilitate recycling and garbage incineration and power generation, and may improve combustion heat energy of garbage in an incinerator. However, garbage containing a large amount of glass and plastic products, may not be identified and screened by a single apparatus at a time. At this time, a fixed sorting mechanical arm may be changed into a mechanical arm movable freely on the ground. Through learning and communication of the machines on the basis of the federated learning, a machine at a back end of a sorting line may perform expected task actions in advance through information transmitted by a front-end machine; meanwhile, the back-end machine may also feed working conditions at the back end back to the front-end machine in time; and even the front-end machine may move to back-end operating procedures, such that sorting efficiency of the machines in the whole system is increased.

In summary, in the system 100, 200 for collaboration and optimization of the edge machines based on the federated learning 400 provided by the embodiments of the present disclosure, the edge machines form the federated learning systems 106, 206, and by training 329, 414 the system collaborative operating model 339, the intelligent level of the single machine may be improved, operating efficiency of the single machine may be optimized and improved 340, an intelligent process of the single machine may be accelerated 352, rapid adjustment and adaptation capabilities 350 to operating environments may be improved, and working efficiency may be constantly optimized. Collaboration 351 among the machines in the system 100, 200 is improved, rapid decomposition of the system tasks is optimized, and adaptability of the system to more complex working tasks in dynamically changing environments is enhanced, for example, processes in production and manufacturing environments are optimized, and overall efficiency of the system is improved. The system collaborative execution task model obtained by joint training all the members in the task training alliance 331 may improve the overall efficiency of the system, for example, the same enterprise or group may have N factories with the same or similar machines and production tasks, but efficiency of each factory is different, and through optimization of single machine 333 data training and modeling 335 based on the federated learning, machine data training and performance optimization (e.g., 350, 351, 352) of systems may be further carried out.

The purposes, the technical solutions and the beneficial effects of the present disclosure are described in further detail with reference to the above embodiments. It should be understood that the above embodiments are merely specific embodiments of the present disclosure but not intended to limit the present disclosure, and any modifications, equivalent replacements, improvements, etc., made within the spirit and principles of the present disclosure should fall within the scope of protection of the present disclosure.

What is claimed is:

1. A system for collaboration and optimization of edge machines based on federated learning, comprising:
R federated learning systems, wherein R≥1, an i-th federated learning system in the R federated learning systems comprises Mᵢ edge machines with uneven operating experience distribution, Mᵢ≥2, i=1, . . . , R;
a model parameter assignment unit, configured to assign initial parameters for federated learning to the Mᵢ edge machines in the i-th federated learning system, receive intermediate model parameters transmitted by model training and optimizing units, and aggregate and update the received intermediate model parameters to obtain new model parameters; and
the model training and optimizing units, arranged in the Mᵢ edge machines respectively, and configured to train, on the basis of the initial parameters assigned by the model parameter assignment unit and respective operating data, local operating models, transmit the intermediate model parameters obtained after training to the model parameter assignment unit, and obtain a system collaborative operating model of the i-th federated learning system according to the new model parameters, wherein the local operating models are models in response to different operating environments.

2. The system according to claim 1, wherein the Mᵢ edge machines comprise Tᵢ specific edge machines with operating experience not meeting predetermined requirements, 1≤Tᵢ<Mᵢ; and the system further comprises:
scenario feature model optimizing units, arranged in the Tᵢ specific edge machines, and configured to carry out, on the basis of the system collaborative operating model and working scenario features of the Tᵢ specific edge machines, model optimization, to increase single machine intelligence and improve capabilities of the Tᵢ specific edge machines to respond to environments, in which the Tᵢ specific edge machines are located, and to execute tasks.

3. The system according to claim 2, wherein the operating experience not meeting the predetermined requirements comprises one of:
a number of operating scenarios experienced being lower than a predetermined value;
a quantity of operating data being less than a predetermined quantity; or
operating duration being shorter than a predetermined time.

4. The system according to claim 1, wherein:
when the Mᵢ edge machines in the i-th federated learning system are organizations with visible data privacy, the intermediate model parameters are transmitted without encryption; and
when the Mᵢ edge machines in the i-th federated learning system are organizations with invisible data privacy, the intermediate model parameters need to be transmitted with encryption.

5. The system according to claim 4, wherein the encryption comprises homomorphic encryption, and the homomorphic encryption comprises fully homomorphic encryption.

6. The system according to claim 1, further comprising:
a machine selection unit, configured to select edge machines with performance scores of executing a target task higher than a predetermined score value in each of the R federated learning systems to obtain a task training alliance;
a task model parameter assignment unit, configured to assign task initial parameters to the edge machines in the task training alliance, receive task model intermediate parameters transmitted by task model training and optimizing units, and aggregate and update the received task model intermediate parameters to obtain new task model parameters; and
the task model training and optimizing units, arranged in the edge machines in the task training alliance respectively, and configured to train, on the basis of the task initial parameters assigned by the task model parameter assignment unit and respective operating data, local operating models for the target task, encrypt the task model intermediate parameters obtained after training and transmit the encrypted task model intermediate parameters to the task model parameter assignment unit, and obtain a system collaborative execution task model of the task training alliance according to the new task model parameters, wherein the local operating models for the target task are models for executing the target task in different operating environments.

7. The system according to claim 1, wherein the model parameter assignment unit is further configured for recording and making statistics on activity data in the federated learning systems, wherein recording and making statistics on activity data in the federated learning systems comprise: a number of the edge machines participating in computation, a number of model transfers, and transmission and convergence determination of the updated model parameters.

8. The system according to claim 1, wherein an edge machine with a computing capability and storage capability meeting predetermined requirements in the Mᵢ edge machines serves as the model parameter assignment unit.

9. The system according to claim 1, wherein a cloud server or an edge server capable of communicating with the Mᵢ edge machines serves as the model parameter assignment unit.

10. The system according to claim 1, wherein each of the Mᵢ edge machines in the i-th federated learning system in the R federated learning systems further comprises:
a data acquisition module, configured to acquire an image, a movement track, operating data and environment responding data;
a storage unit, configured to store the operating data for model training;
a computing unit, of which one part is configured to execute a predetermined working task and another part is configured to execute a task for the federated learning; and
a communication module, which supports wired communication and wireless communication, wherein the wireless communication involves a 5G communication module.
